(19) United States
(12) Patent Application Publication
(10) Pub. No.: US 2026/0271819 A1
(43) Pub. Date: Sep. 17, 2026

(54) Hydraulic System with Reservoir Surge Energy Recovery and Inlet Flow Supplement for Surface Engaging Machinery

(71) Applicant: Parker-Hannifin Corporation, Cleveland, OH (US)

(72) Inventors: Joseph P. Reilly, Grayslake, IL (US); Nathan Rosenbaum, Buffalo Grove, IL (US)

(21) Appl. No.: 19/168,092

(22) PCT Filed: Apr. 23, 2024
(86) PCT No.: PCT/US2024/025763

§ 371 Date: Sep. 23, 2025

Related U.S. Application Data
(60) Provisional application No. 63/513,364, filed on Jul. 13, 2023.
(60) Provisional application No. 63/603,978, filed on Nov. 29, 2023.

(51) Int. Cl. A01B 63/32; F15B 3/00; F15B 11/032

(52) U.S. Cl. CPC A01B 63/32; F15B 3/00; F15B 11/032

(57) ABSTRACT

An example hydraulic system includes: a plurality of unit cylinder actuators; a source of fluid, wherein the source is fluidly coupled to the plurality of unit cylinder actuators; and an intensifier that is fluidly coupled to the plurality of unit cylinder actuators, wherein the intensifier (i) receives fluid from a first subset of unit cylinder actuators of the plurality of unit cylinder actuators, and (ii) provides fluid having an increased pressure level relative to pressure level of received fluid to a second subset of unit cylinder actuators of the plurality of unit cylinder actuators, thereby supplementing fluid from the source.

### CROSS REFERENCE TO RELATED APPLICATION

The present application claims priority to U.S. Provisional Patent Application No. 63/513,364, filed on Jul. 13, 2023, and U.S. Provisional Patent Application No. 63/603,978, filed on Nov. 29, 2023, the entire contents of all of which are herein incorporated by reference as if fully set forth in this description.

### BACKGROUND

Conventional surface engaging machines (e.g., planters, seeders, tillage machines, mowers, planter row cleaners, a rotary broom/brush that could move debris from sidewalks, etc.) used springs, weights, or air bags in an attempt to maintain surface contact between a unit of the machine and the surface. Recent advancements have incorporated fluid power cylinders into these systems.

In an example, as an agricultural surface (e.g., ground) engaging unit travels across fields, it is difficult to maintain constant surface engagement position (e.g., seeding depth) and other parameters using such conventional methods due to changing soil conditions (soil types, moisture, surface height, etc.). This problem is exacerbated by demands for machines to travel at faster speeds. It may thus be desirable to be able to vary the downforce (downward force) to adapt to different soil conditions.

One solution to such problem is to replace conventional downforce methods (e.g., spring, weights, or airbag) with an active force control system. Such an active force control system may enable precise hydraulic control of the downforce.

Some machines may include several surface engaging units (e.g., 16-48 row units). As the number of units and machine speed increase, dynamic flow demands might become a limiting factor to machine productivity. For example, the primary flow source of a machine might not be able to keep up with the total flow demand. Furthermore, the energy wasted as the increasing exhaust fluid of each unit flows through restrictive tank lines increases with the machine speed. This may cause the hydraulic system of the machine to be inefficient.

It may thus be desirable to configure the hydraulic system in a manner that enables controlling forces with high precision at high machine speeds, while enhancing efficiency of the hydraulic system. It is with respect to these and other considerations that the disclosure made herein is presented.

### SUMMARY

The present disclosure describes implementations that relate to a hydraulic system with reservoir surge energy recovery and inlet flow supplement for surface engaging machinery.

In a first example implementation, the present disclosure describes a hydraulic system. The hydraulic system includes: a plurality of unit cylinder actuators; a source of fluid, wherein the source is fluidly coupled to the plurality of unit cylinder actuators; and an intensifier that is fluidly coupled to the plurality of unit cylinder actuators, wherein the intensifier (i) receives fluid from a first subset of unit cylinder actuators of the plurality of unit cylinder actuators, and (ii) provides fluid having an increased pressure level relative to pressure level of received fluid to a second subset of unit cylinder actuators of the plurality of unit cylinder actuators, thereby supplementing fluid from the source.

In a second example implementation, the present disclosure describes a surface engaging machine including the hydraulic system of the first example implementation.

In a third example implementation, the present disclosure describes a method of operating the hydraulic system of the first or second example implementation or the surface engaging machine of the second example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1A illustrates a partial view of a surface engaging machine, according to an example implementation.

FIG. 1B illustrates a schematic view of a surface engaging unit of the surface engaging machine of FIG. 1A, according to an example implementation.

FIG. 2 illustrates a hydraulic system, according to an example implementation.

FIG. 3 is a flowchart of a method 300 of operating a hydraulic system of a surface engaging machine, according to an example implementation.

### DETAILED DESCRIPTION

Disclosed herein are systems and methods for enabling surface engaging machines to control surface engagement forces (e.g., downward forces) with high precision and enhanced hydraulic system efficiency. The term “surface” is used throughout herein to indicate any vertical or horizontal surface or plane. Example surfaces include ground, soil, wall, road, machine surfaces, etc. Further, example surface engaging machinery could include a seeder or planter, a tillage implement, a grass cutting machine, planter row cleaners, road resurfacing machines, etc.

Particularly, the systems, machines, and methods described herein enable cross-flow between units of a surface engaging units to supplement flow from a primary source of flow when the primary source is unable to keep up with flow demand. Notably, this operation is accomplished in a passive manner via an intensifier, without active control management, additional hydraulic storage devices, or conversion of hydraulic energy to electrical or mechanical energy that is stored in energy stored devices.

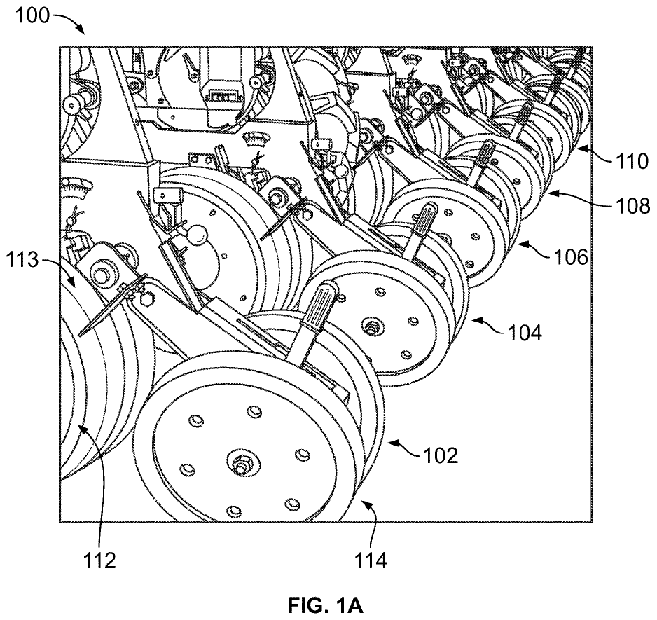

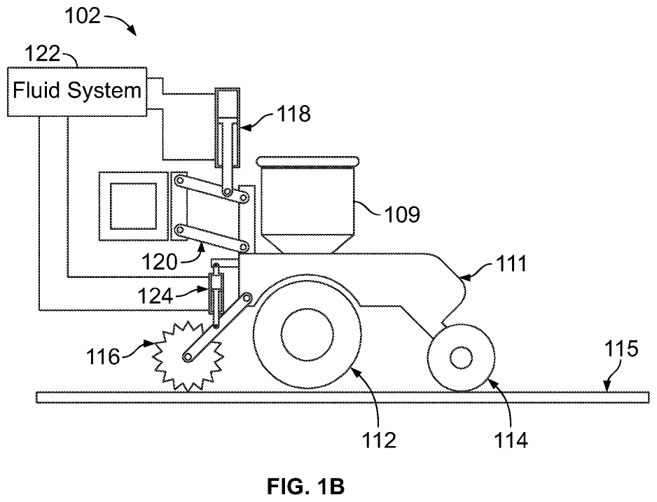

FIG. 1A illustrates a partial view of a surface engaging machine 100, according to an example implementation. The surface engaging machine 100 shown in FIG. 1A can be a seeder or planter that is attached to a tractor, for example. A seeder/planter is used herein as an example. However, it should be understood that the systems, methods, and concepts discussed herein are applicable to any surface engaging machine such as tillage machines, mowers, row unit cleaners, a rotary broom/brush that could move dust from sidewalks, or any other machine that requires engagement of an implement with the surface.

The surface engaging machine 100 has several surface engaging row units (e.g., 16-48 units) such as row unit 102, row unit 104, row unit 106, row unit 108, and row unit 110. As the surface engaging machine 100 traverses a field, each row unit sows or plants seeds in straight lines in raised or flat soil beds. The row unit 102 further includes back wheels 114 that close the trench after depositing the seeds therein.

FIG. 1B illustrates a schematic view of the row unit 102, according to an example implementation. Referring to FIGS. 1A, 1B together, the surface engaging machine 100 can have a seed tank 109 storing seeds (e.g., corn, soy, etc.). Blowers can be used to direct seeds from the seed tank 109 through seed tubes (not shown) to the row units 102-110.

The row unit 102 can have a surface engaging implement 111 including gauge wheels 112 (e.g., adjustable wheels attached to a plow or planter to regulate the depth of penetration into the soil) and disk openers 113 (see FIG. 1A), which include metal disks that contact a surface 115 (e.g., ground) to cut a trench at a particular depth to plant the seeds. The height of the gauge wheels 112 controls the height of the disk openers 113. For instance, raising the gauge wheels 112 can lower the disk openers 113 to cut a deeper trench and vice versa.

As the depth of the trench that the seed opener digs is correlated with the height of the gauge wheels 112, it may be desirable to maintain contact between the gauge wheels 112 and the surface 115 as the surface engaging machine 100 traverses the field. To maintain such contact, it may be desirable to have the individual row units apply a particular downforce on the respective gauge wheels so as to maintain surface contact and to firm the soil at the edges of the trench in which the seed is placed.

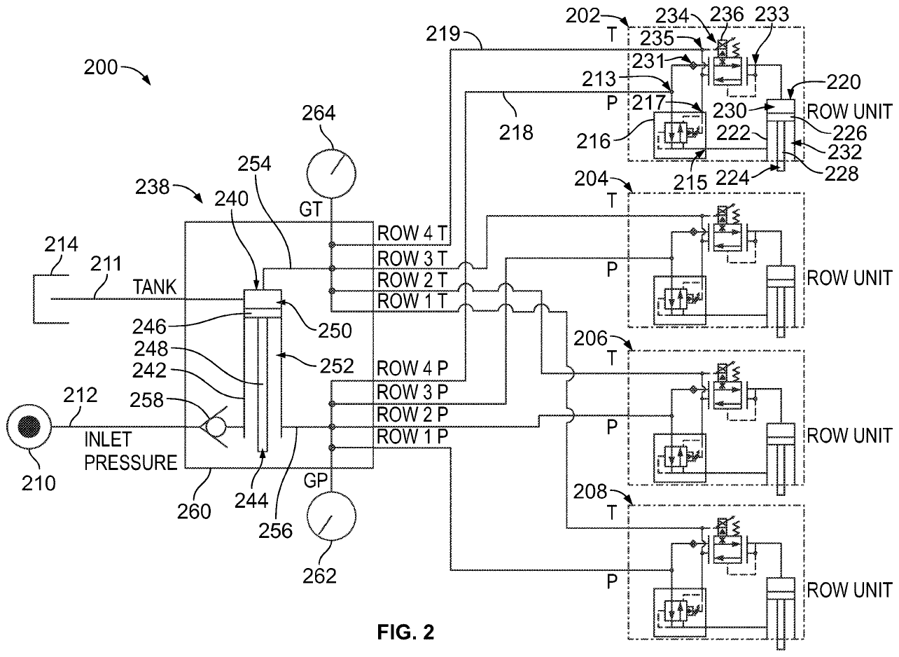

The row unit 102 can include a cylinder actuator 118 that is coupled to the surface engaging implement 111 and configured to apply a downforce thereto. In an example, the cylinder actuator 118 can be coupled to the surface engaging implement 111 via a linkage 120. The cylinder actuator 118 is configured to apply a downforce on the surface engaging implement 111. Such downforce causes the gauge wheels 112 and the disk openers 113 to apply a corresponding downforce force on the surface 115, and may thus affect the surface engagement position of the disk openers 113. A fluid system 122 (e.g., as described below with respect to FIG. 2) is used to control fluid flow to and from the cylinder actuator 118 to change the force applied by the cylinder actuator 118 to the surface engaging implement 111.

In an example, the row unit 102 also has a row cleaner 116 formed as a spiked wheel. The row cleaner 116 is disposed ahead of the gauge wheel 112 and the disk openers 113, and is configured to move residue and clods out of the way of the disk openers 113 and the gauge wheels 112 to allow them to operate smoothly and to help eliminate unit vibration or bounce.

In an example, the downforce of the row cleaner 116 can be controlled via another cylinder actuator 124. The fluid system 122 can be used to control fluid flow to and from the cylinder actuator 124 to change the force applied by the row cleaner 116 to the surface 115, and thus change the engagement position of the row cleaner 116.

Soil conditions can vary widely. For instance, the surface engaging machine 100 may be subjected to different soil types: sand, clay, rock, etc. Further, individual row units of the surface engaging machine 100 can each be subjected to different soil conditions. For instance, moisture might not be consistent throughout the surface, e.g., ground in this case, and thus different row units may be subjected to different ground firmness. Further, the ground might be uneven, and thus different row units may be traversing over varying ground heights as the surface engaging machine 100 traverses the field. Thus, it may be desirable to actively control the downforce applied to the gauge wheels (or the row cleaner) of each row unit based on the condition of the soil.

For example, for hard soil or aggressive organic material conditions, it may be desirable to apply a positive downforce by the cylinder actuator 118 on the surface engaging implement 111 or positive downforce to the cylinder actuator 124 on the row cleaner 116. Such positive downforce along with the weight of the surface engaging implement 111 may facilitate achieving a particular surface engagement position.

In other examples however, the soil may be soft. In these examples, rather than applying a positive downward force, it may be desirable to have the cylinder actuator 118, 124 apply a low magnitude upward force that is less than the weight of the surface engaging implement 111 or the row cleaner 116. This way, a resultant or effective small downward force that is equal to the difference between the weight of the surface engaging implement 111 or the row cleaner 116 and the upward actuator force is applied downward on the soft soil.

As such, it may be desirable to control the actuator force with high precision to achieve a particular desirable effective downward force while allowing the surface engaging machine 100 to traverse the field at high speeds. A hydraulic control system might enable such force control.

FIG. 2 illustrates a hydraulic system 200, according to an example implementation. The hydraulic system 200 is configured to control at least some of surface engaging units of the surface engaging machine 100. For example, the hydraulic system 200 is configured to control a surface engaging unit 202, surface engaging unit 204, surface engaging unit 206, and surface engaging unit 208. The surface engaging units 202-208 can represent a subset of the row units 102-110 of the surface engaging machine 100, for example. Although four surface engaging units are shown in FIG. 2, it should be understood that the hydraulic system 200 can be configured to control more or fewer surface engaging units.

The hydraulic system 200 includes a source 210 of fluid capable of providing fluid via supply fluid line 212 in a wide range of pressure levels, e.g., 80-3000 pounds per square inch (psi). In other words, the source 210 can be a variable pressure fluid source.

The source 210 of fluid can include a pump, an accumulator, another valve in a fluid system of the machine, a cylinder, etc. In an example, the source 210 can include a fluid flow providing device (e.g., a fixed or variable displacement pump) combined with one or more valves that are configured to be electronically-actuated by an electronic controller to regulate pressure level of fluid provided by the source 210. For example, the controller can be configured to send a signal to a solenoid of a valve to actuate the valve and achieve a particular pressure level for fluid provided by the source 210.

The hydraulic system 200 also includes a fluid reservoir 214 that can store fluid at a low pressure level (e.g., atmospheric pressure or 0-50 psi). In an example where the source 210 of fluid includes a pump, such pump can draw fluid from the fluid reservoir 214, then provide pressurized fluid to other components of the hydraulic system 200. The fluid reservoir 214 also receives return fluid via reservoir line 211.

The surface engaging unit 202 includes a pressure control valve 216 configured to receive supply fluid via unit supply line 218. The pressure control valve 216 is configured to maintain fluid at a particular pressure level or within a particular pressure level range downstream of the pressure control valve 216.

As an example, as depicted symbolically in FIG. 2, the pressure control valve 216 can be a hydro-mechanical pressure reducing-relieving valve. A pressure reducing valve can provide a steady pressure into a part of the hydraulic system 200 that operates at a pressure level that is lower than normal system pressure (e.g., lower than pressure level of fluid provided by the source 210). A pressure reducing valve can be set for a desired downstream pressure within its design limits. For example, the pressure control valve 216 can receive fluid from the source 210 at a pressure level in the range 2800-3000 psi and provide fluid downstream at a reduced pressure level of 600 psi.

A pressure relief valve is a valve used to control or limit the pressure in a system. Pressure might otherwise build up and can cause component or system failure. The pressure control valve 216 combines or integrates a pressure relief function with a pressure reducing function so as to maintain pressure level downstream thereof substantially constant. The term “substantially constant” is used herein to indicate that pressure level can be maintained within a threshold value (e.g., within 2%-5%) of a desired pressure level. For example, if a desired pressure level is 600 psi, the pressure control valve 216 can maintain pressure level downstream in the range of 580-620 psi.

In the example implementation of FIG. 2, the pressure control valve 216 can have an inlet port 213 that is fluidly coupled to the unit supply line 218, (ii) an outlet port 215 through which fluid is discharged downstream of the pressure control valve 216, and (iii) a drain port 217 that is fluidly coupled to unit return line 219. The term “fluidly coupled” is used throughout herein to indicate that fluid can flow or be communicated between two fluid passages, chambers, ports, or openings.

In an example, the pressure control valve 216 can be a normally-open pressure control valve configured to reduce a high pressure received at the inlet port 213 to a controlled lower pressure (reduced pressure) at the outlet port 215. The reduced pressure is determined by a biasing force of a spring plus any pressure at the drain port 217. The biasing force of the spring can be adjustable (e.g., manually) as depicted symbolically in FIG. 2.

The pressure control valve 216 further integrates pressure relief valve function from the reduced pressure at the outlet port 215 to the drain port 217. Particularly, the pressure control valve 216 allows the reduced pressure at the outlet port 215 to remain relatively constant under back flow conditions, e.g., if back flow is received at the outlet port 215 at a higher pressure level than the set reduced pressure level. Such higher pressure level fluid at the outlet port 215 is relieved to the drain port 217 and the unit return line 219 to maintain pressure level at the outlet port 215 substantially constant.

The outlet port 215 of the pressure control valve 216 is fluidly coupled to a unit cylinder actuator 220. The unit cylinder actuator 220 can represent the cylinder actuator 118 or the cylinder actuator 124, for example. The unit cylinder actuator 220 includes a cylinder 222 and a piston 224 that is slidably accommodated (axially movable) in the cylinder 222.

The piston 224 includes a piston head 226 and a piston rod 228 extending from the piston head 226 along a central longitudinal axis direction of the cylinder 222. The piston rod 228 can be coupled to the surface engaging implement 111 of the row unit 102 of the surface engaging machine 100, for example.

The piston head 226 divides the internal space of the cylinder 222 into a first chamber 230 and a second chamber 232. The pressure control valve 216 is fluidly coupled to the second chamber 232 of the unit cylinder actuator 220 as shown in FIG. 2.

Fluid can be received from the unit supply line 218 at the inlet port 213 of the pressure control valve 216, which reduces pressure level and discharges fluid through its outlet port 215 to the second chamber 232 of the unit cylinder actuator 220. Thus, fluid a particular pressure level (e.g., 600 psi) from the pressure control valve 216 is provided to the second chamber 232.

Fluid in the second chamber 232 applies a force on the piston 224 in a first direction (e.g., upward in FIG. 2). Assuming that a diameter of the piston head 226 is D₁, then a surface area of the piston head 226 can be determined as

$${A}_{1} = π \frac{{D}_{1}^{2}}{4} .$$

Assuming that a diameter of the piston rod 228 is D₂, then a surface area of the piston 224 on which fluid in the second chamber 232 acts is the annular area that can be determined as

$${A}_{2} = π \frac{{D}_{1}^{2}}{4} - π \frac{{D}_{2}^{2}}{4} .$$

Assuming pressure level of fluid in the second chamber 232 (which is controlled by the pressure control valve 216) is P₂, then a fluid force F₂ that the fluid in the second chamber 232 applies on the piston 224 can be determined as

$${F}_{2} = {P}_{2} \cdot {A}_{2} = {P}_{2} \cdot ( π \frac{{D}_{1}^{2}}{4} - π \frac{{D}_{2}^{2}}{4} ) .$$

Because the pressure control valve 216 causes P₂ to be a substantially constant pressure level, the force F₂ is a substantially constant fluid force.

The hydraulic system 200 further includes a proportional pressure control valve 234 that can control fluid flow and pressure level in the first chamber 230. The proportional pressure control valve 234 can have (i) an inlet port 231 that is fluidly coupled to the unit supply line 218, (ii) an outlet port 233 that is fluidly coupled to the first chamber 230, and (iii) a return port 235 that is fluidly coupled to the unit return line 219.

The proportional pressure control valve 234 can include movable element (e.g., spool, poppet, or piston) disposed therein. The position of the movable element within the valve controls the size of a restriction or flow area through the proportional pressure control valve 234.

The proportional pressure control valve 234 can be electrically-actuated via a solenoid actuator 236. For example, the hydraulic system 200 can include a controller configured to send an electric command signal to the solenoid actuator 236 to actuate the proportional pressure control valve 234. The controller can include one or more processors or microprocessors and may include data storage (e.g., memory, transitory computer-readable medium, non-transitory computer-readable medium, etc.). The data storage may have stored thereon instructions that, when executed by the one or more processors of the controller, cause the controller to perform operations described herein.

The proportional pressure control valve 234 can operate as a proportional pressure reducing valve. Particularly, the solenoid actuator 236 receives a valve command signal from the controller, and responsively modulates (e.g., changes the position of) the movable element of the proportional pressure control valve 234 to reduce the pressure level at the outlet port 233 compared to pressure level at the inlet port 231 based on the magnitude of the command signal provided to the solenoid actuator 236. The smaller the magnitude of the command, the smaller the flow area of the proportional pressure control valve 234, and the pressure level at the outlet port 233 decreases. Conversely, the larger the magnitude of the valve command signal, the larger the flow area of the proportional pressure control valve 234, and the pressure level at the outlet port 233 increases.

The outlet port 233 of the proportional pressure control valve 234 is fluidly coupled to the first chamber 230, and thus fluid having pressure level at the outlet port 233 applies a force on the piston 224 in a second direction (e.g., downward in FIG. 2) opposite the first direction. Assuming pressure level of fluid in the first chamber 230 (which is controlled by the proportional pressure control valve 234) is P₁, then a respective fluid force F₁ that fluid in the first chamber 230 applies on the piston 224 can be determined as

$${F}_{1} = {P}_{1} \cdot {A}_{1} = {P}_{1} \cdot π \frac{{D}_{1}^{2}}{4} .$$

Thus, the resultant or net fluid force acting on the piston 224 can be determined as Fₙₑₜ=F₁−F₂=P₁·A₁−P₂·A₂. In the example implementation shown in FIG. 2, the pressure level P₂ in the second chamber 232, and thus the force F₂, is substantially constant due to the pressure control valve 216. By varying the valve command to the proportional pressure control valve 234, the pressure level P₁ in the first chamber 230 and the force F₁ can be changed to adjust the net fluid force Fₙₑₜ. The net fluid force Fₙₑₜ applied to the piston 224 is transmitted to the implement (e.g., the surface engaging implement 111 and thus the gauge wheels 112) coupled to the piston 224, and the implement then applies the force to the surface (e.g., ground). With this configuration, the downward force or the net fluid force Fₙₑₜ that the piston 224 applies to the surface engaging implement can be adjusted by varying the valve command to the proportional pressure control valve 234 until a desired downward force is achieved.

For instance, if the unit supply line 218 has fluid at a particular pressure level of 3000 psi, the proportional pressure control valve 234 can vary the pressure in the first chamber 230 proportionally between 0 psi to about 3000 psi. Thus, the force F₁ applied to the piston 224 downward can vary between a low value and a high value. With this configuration, the net fluid force Fₙₑₜ can vary in a continuum between a net downward force and a net upward force based on the magnitude of the valve command signal to the solenoid actuator 236.

To facilitate achieving a desired net force, the unit cylinder actuator 220 can include one or more sensors configured to provide information indicative of the actual net force Fₙₑₜ applied to the piston 224. For example, the unit cylinder actuator 220 can include a force sensor. Various types of force sensors or force transducers can be used. Example force sensors include a load cell, a strain gauge force sensor, a piezoelectric force sensor, an inductive force sensor, a capacitive force sensor, a magnetostrictive force sensors, pressure sensors in each of the chambers 230, 232, etc. Thus, the term “force sensor” is used throughout herein to indicate one or more sensors capable of providing force sensor information that can be used to determine the actual force acting on the piston 224.

The force sensor can be coupled to the piston rod 228 to which a machine implement (seed opener or gauge wheels) is attached. The controller is in communication with, and receives sensor information from, the force sensor, and accordingly determines the net force Fₙₑₜ applied to the piston 224 (and thus applied by the implement coupled to the piston 224 to the surface). In examples, the force sensor or an additional force sensor can be coupled to the gauge wheels 112 so that the force sensor can account for differences in weight of the row unit, which can vary based on brand, whether full seed load is included, etc.

The controller can receive input information including input commands indicating a target net force Fₙₑₜ, and also receives sensor information from the force sensor. In response, the controller provides a valve command signal to the proportional pressure control valve 234 (e.g., to the solenoid actuator 236) to vary the pressure level in the first chamber 230 until the desired net force is achieved.

Particularly, the controller can compare the actual net force Fₙₑₜ indicated by the force sensor to a target or desired net force, and then adjust the valve command signal (i.e., adjust the magnitude of the electric current or voltage) sent to the solenoid actuator 236 of the proportional pressure control valve 234 to achieve the target net force. As such, the controller can implement a closed-loop feedback control system to achieve the target net force based on the feedback signal from the force sensor.

Notably, in addition to the proportional pressure control valve 234 operating as a pressure reducer valve, it also operates in a second mode of operation as a pressure relief valve. Particularly, if a pressure spike occurs in the first chamber 230 (at the outlet port 233 of the proportional pressure control valve 234), the proportional pressure control valve 234 relieves fluid from the first chamber 230 to the return port 235, which is fluidly coupled to the unit return line 219.

The surface engaging units 204-208 are configured similar to the surface engaging unit 202 and may have similar components.

The hydraulic system 200 can operate in several modes depending on whether the source 210 is able to satisfy flow demand of all units (and/or other hydraulic fluid consuming devices of the surface engaging machine 100) while maintaining a particular pressure level such as 3000 psi.

A first mode of operation of the hydraulic system 200 and the surface engaging machine 100 can be referred to as static condition mode. In this first mode of operation, a target downforce for the surface engaging units 202-208 is set to a particular value, while the surface engaging machine 100 (e.g., tractor) is stationary (not moving). In this mode, the source 210 can provide fluid at a pressure such as 3000 psi, while the respective proportional pressure control valves (e.g., the proportional pressure control valve 234) can set the pressure level in the respective first chambers (e.g., the first chamber 230) at 1500 PSI, for example. In this condition or mode, all the surface engaging units 202-208 are actively managing that pressure level (e.g., 1500 psi at the first chambers), and the inlet pressure provided by the source 210 has a margin above the target pressure. The source 210 is able to maintain such margin. The pressure level in the unit return line 219 and/or the reservoir line 211 can be about 100 psi due to pressure losses resulting from line restrictions (e.g., due to couplings, fittings, tubes, hoses, etc.).

A second mode of operation of the hydraulic system 200 and the surface engaging machine 100 can be referred to as a dynamic mode with normal inlet pressure. In this dynamic condition, a target downforce is set by setting a target pressure level (e.g., 1500 psi) in the first chambers, and the surface engaging machine 100 (e.g., tractor) is moving at a low speed such as 5 miles per hour (MPH) on stable ground surface conditions (e.g., substantially flat ground and consistent soil condition). In this mode, the source 210 is also able to provide fluid at the 3000 psi (e.g., at a margin above the target pressure of 1500 psi). In this mode of operation, with the substantially stable ground surface condition, some of the pistons of some surface engaging units might be moving upward (jousting motion) while other pistons of other surface engaging units might be moving downward (rebounding motion), but the degree of out of phase movements is limited by the substantially flat ground. As such, the surface engaging units with jousting (moving upward) pistons may have first chambers (similar to the first chamber 230) having a pressure level (e.g., 1600 psi) that is slightly higher than the target pressure and are relieved to the unit return lines via respective proportional pressure control valves operating as pressure relief valves. On the other hand, the surface engaging units with rebounding (moving downward) pistons may have first chambers (similar to the first chamber 230) having the target pressure level (e.g., 1500 psi). Such imbalances, however, are limited by stable ground surface conditions. In this mode, the pressure level in the unit return line 219 and/or the reservoir line 211 can be slightly higher (e.g., about 300 psi) given that some of the fluid is being relieved thereto from some of the surface engaging units and the line restrictions.

A third mode of operation of the hydraulic system 200 and the surface engaging machine 100 can be referred to as a dynamic mode with starved inlet pressure. In this dynamic condition, a target downforce is set by setting a target pressure level (e.g., 1500 psi) in the first chambers, and the surface engaging machine 100 (e.g., tractor) can be moving at a low speed such as 5 MPH, but on a highly varying ground surface condition. Such highly varying ground surface condition and other demands on the hydraulic system 200 cause the source 210 to be unable to supply enough fluid flow to maintain a particular pressure level in the respective unit supply lines.

This mode of operation may occur, for example, as the number of active surface engaging units of the surface engaging machine 100 increases. For example, in some operating conditions, a number of surface engaging units may demand fluid at a high pressure level at the same time to be provided to their respective first chambers. Other fluid consuming device of the surface engaging machine 100 may also be demanding fluid from the source 210. In such conditions, the source 210 may be required to provide fluid at a pressure level that is higher than the pressure level to be supplied to the respective first chambers via the respective proportional pressure control valves, but might not be able to. For instance, if the force to be applied by the pistons require a pressure level of about 1500 psi in the respective first chambers, the source 210 should provide fluid at about 3000 psi to accommodate any pressure losses in the fluid lines. However, if a sufficiently large number of units demand such pressure level at the same time, the source 210 might not have the capacity to supply sufficient fluid flow rate to achieve the desired pressure level at the unit supply lines even if the controller fully opens the respective proportional pressure control valves. As an example for illustration, the source 210 may be able to provide fluid at a pressure level of only 900 psi, which is not sufficient to satisfy the demand by the various units.

In other words, in some cases, the hydraulic system 200, and particularly the source 210, might not have enough capacity to supply sufficient fluid to maintain a desired pressure level and desired respective forces for all the unit cylinder actuators. This issue may be exacerbated by pressure losses in the many fluid lines (hoses, tubes, connections, etc.) between the source 210 and the various surface engaging units.

The hydraulic system 200, however, includes an intensifier 238 interposed between the source 210 and the surface engaging units, and the intensifier 238 may alleviate such insufficient capacity issue that may occur in this dynamic mode with a starved source. Particularly, the intensifier 238 is configured to use fluid from unit cylinder actuators with upward moving pistons (jousting pistons) and provide fluid to unit cylinder actuators with downward moving pistons (rebounding pistons) to compensate for the limited capacity of the source 210 under some operating conditions.

Notably, due to the varying ground surface conditions in this mode, the unit cylinder actuators of the respective surface engaging units can be out of phase relative to each other. Particularly, the terrain on which the surface engaging machine 100 operates in this mode is typically uneven, with crest portions (e.g., portions having rising or sloping upward ground) and trough portions (e.g., portions having falling or sloping downward ground). Thus, a first subset of surface engaging units may be traversing crest portions while a second subset of surface engaging units may be traversing trough portions.

The intensifier 238 uses such out of phase condition to compensate for the flow capacity limitations of the source 210. In particular, pistons of the first subset of unit cylinder actuators that are moving upward force fluid (from the respective first chambers) to surge in the respective unit return lines, providing such fluid back to the intensifier 238. The intensifier 238 then intensifies (increases) the pressure level of the fluid, and provides fluid with intensified pressure level to the second subset of unit cylinder actuators that require fluid (with downward moving pistons), supplementing fluid from the source 210 and stabilizing pressure level of fluid provided to the unit cylinder actuators. In other words, the intensifier 238 allows cross flow or cross feeding from the first subset of unit cylinder actuators to the second set of unit cylinder actuators.

In the example implementation of FIG. 2, the intensifier 238 includes an intensifier cylinder actuator 240 having a intensifier cylinder 242 and a intensifier piston 244 that is slidably accommodated (axially movable) in the intensifier cylinder 242. The intensifier piston 244 includes a piston head 246 and a piston rod 248 extending from the piston head 246 along a central longitudinal axis direction of the intensifier cylinder 242. The piston head 246 divides the internal space of the intensifier cylinder 242 into a head chamber 250 and a rod chamber 252.

As depicted, the head chamber 250 is fluidly coupled to the reservoir line 211, and the rod chamber 252 is fluidly coupled to the supply fluid line 212. With this configuration, the source 210 provides fluid to the surface engaging units via the rod chamber 252, and fluid discharged from the surface engaging units is provided to the fluid reservoir 214 via the head chamber 250.

Assuming the piston head 246 has a diameter DH, fluid in the head chamber 250 interacts with a cross-sectional surface area of piston head 246 that can be referred to as piston head area and is equal to

$${A}_{H} = π \frac{{D}_{H}^{2}}{4} .$$

On the other hand, assuming the piston rod 248 has a diameter D_{R}, fluid in the rod chamber 252 interacts with an annular surface area of the intensifier piston 244 that can be referred to as piston annular area

$${A}_{A n n ular} = π \frac{{D}_{H}^{2} - {D}_{R}^{2}}{4} .$$

The area A_{Annular} is smaller than the piston head area A_{H}. Thus, as the intensifier piston 244 extends (e.g., moves downward in FIG. 2) within the intensifier cylinder 242, the amount of fluid flow Q_{H} flowing into the head chamber 250 is greater than the amount of fluid flow Q_{Annular} discharged from the rod chamber 252, whereas pressure level Pout in the rod chamber 252 is intensified (increased) relative to pressure level Pᵢₙ of fluid in the head chamber 250 by an area ratio

$$\frac{{A}_{H}}{{A}_{A n n u l a r}} .$$

Particularly, if the intensifier piston 244 moves at a particular velocity V, then Q_{H}=A_{H}V is greater than

$${Q}_{Annular} = {A}_{Annular} V , and {Q}_{H} = \frac{{A}_{H}}{{A}_{A n n u l a r}} {Q}_{A n n u l a r} .$$

In other words, the fluid discharged from the rod chamber 252 has a flow rate that is reduced relative to the fluid flowing into the head chamber 250 by the area ratio

$$\frac{{A}_{H}}{{A}_{A n n u l a r}}$$

On the other hand, pressure level of fluid in the rod chamber 252 is intensified or increased by the same area ratio

$$\frac{{A}_{H}}{{A}_{A n n u l a r}}$$

relative to the pressure level in the head chamber 250.

As depicted in FIG. 2, the respective unit return lines (similar to and including the unit return line 219) are connected to a return passage 254 that is fluidly coupled to the head chamber 250 of the intensifier cylinder actuator 240. On the other hand, the respective unit supply lines (similar to and including the unit supply line 218) are connected to a supply passage 256 that is fluidly coupled to the rod chamber 252 of the intensifier cylinder actuator 240.

With this configuration, if one or more of the surface engaging units are traversing crest portions, and their respective pistons move upward, pressure may surge or spike for a small period of time (e.g., 50-100 millisecond) in the respective first chambers of the unit cylinder actuators, causing pressure to also spike in the unit return lines, the return passage 254, and the head chamber 250. Such pressure spike, is further intensified by the intensifier cylinder actuator 240 as described above, such that fluid at an increased pressure level (but reduced flow rate) is discharged from the supply passage 256 to the respective unit supply lines. The intensifier 238 may have a check valve 258 that prevents fluid discharged from the rod chamber 252 from back flowing to the source 210. Rather, fluid is directed from the rod chamber 252 to the supply passage 256.

As an example for illustration, assuming the area ratio

$$\frac{{A}_{H}}{{A}_{A n n u t a r}}$$

is 4, if pressure level of the fluid surging back to the head chamber 250 via the unit return lines is 500 psi, then fluid discharged from the rod chamber 252 has a pressure level of about 2000 psi. Such fluid is provided to the respective unit supply lines to ensure that they have sufficient pressure level in conditions where the source 210 is not able to provide sufficient fluid flow (e.g., if the source 210 provides fluid at a pressure level such as 900 psi that is not sufficient to achieve desired force levels). As such, energy recovered from pressure spikes in the unit return lines is transferred with a pressure intensification and flow rate reduction via the intensifier 238 to the unit supply lines. This may allow the surface engaging machine 100 to travel at higher speeds on varying ground conditions, while maintaining accurate downward forces for each unit cylinder actuator.

Further, in examples, the intensifier 238 may be positioned close to the unit cylinder actuators. Thus, any pressure losses due to fluid connections from the intensifier 238 to the unit cylinder actuators may be reduced.

In examples, the intensifier cylinder actuator 240, the check valve 258, various fluid passages and respective ports that are fluidly coupled to the surface engaging units can be integrated into a junction block or manifold 260. Further, the hydraulic system 200 may include a supply pressure sensor 262 and a return pressure sensor 264. The pressure sensors 262, 264 may be configured to provide sensor information indicative of pressure levels in the supply passage 256 and the return passage 254 to the controller of the hydraulic system 200, enabling the controller to monitor pressure spikes provided to the return passage 254, and fluid provided to the supply passage 256.

In examples, the surface engaging machine 100 may have multiple intensifiers similar to the intensifier 238, each intensifier being associated with a group of unit cylinder actuators. For example, in the implementation of FIG. 2, the intensifier 238 is associated with 4 unit cylinder actuators. Thus, for a surface engaging machine having 48 surface engaging units may have 12 intensifiers. This is an example for illustration only. Each intensifier may be associated with more or fewer surface engaging units. For instance, each intensifier may be associated with 6 surface engaging units.

With the configuration shown in FIG. 2, energy recovery from fluid discharged to the return passage 254 is accomplished passively (in a self-actuated manner) via the intensifier 238. There is no active control management system, additional hydraulic storage devices, or conversion of hydraulic energy to electrical or mechanical energy that is stored in energy stored devices. Thus, the configuration of FIG. 2 can supplement the source 210 and increase the efficiency of the hydraulic system 200 at a reduced cost.

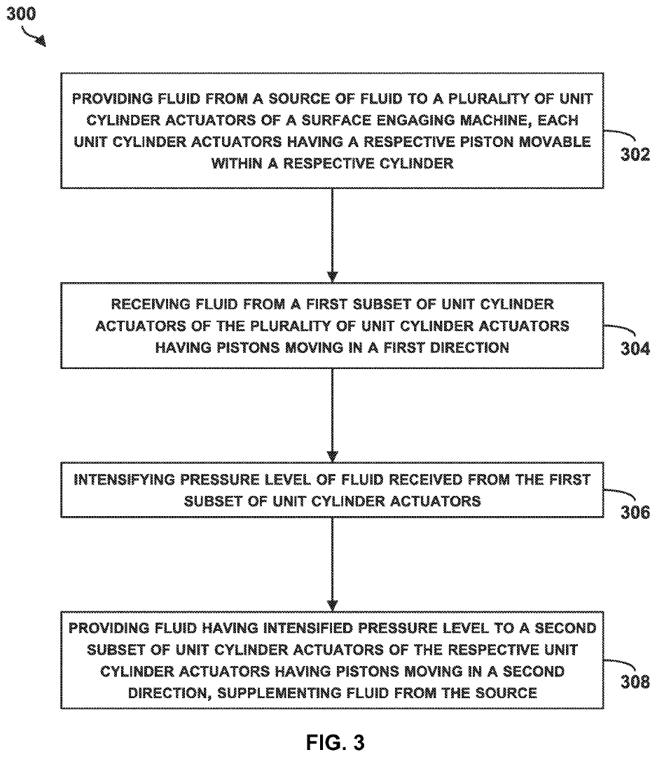

FIG. 3 is a flowchart of a method 300 of operating the hydraulic system 200 of the surface engaging machine 100, according to an example implementation. The method 300 may include one or more operations, or actions as illustrated by one or more of blocks 302-308. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 302, the method 300 includes providing fluid from the source 210 of fluid to a plurality of unit cylinder actuators (e.g., the unit cylinder actuator 220) of the surface engaging machine 100, each unit cylinder actuators having a respective piston (e.g., the piston 224) movable within a respective cylinder (e.g., the cylinder 222).

At block 304, the method 300 includes receiving (e.g., at the head chamber 250 of the intensifier 238) fluid from a first subset of unit cylinder actuators of the plurality of unit cylinder actuators having pistons moving in a first direction (e.g., moving upward in FIG. 2).

At block 306, the method 300 includes intensifying (e.g., by the intensifier cylinder actuator 240 of the intensifier 238) pressure level of fluid received from the first subset of unit cylinder actuators.

At block 308, the method 300 includes providing fluid (e.g., from the rod chamber 252 of the intensifier cylinder actuator 240) having intensified pressure level to a second subset of unit cylinder actuators of the plurality of unit cylinder actuators having pistons moving in a second direction (e.g., downward in FIG. 2), supplementing fluid from the source 210.

The method 300 can include any further steps described throughout his disclosure.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a hydraulic system for a surface engaging machine having a plurality of surface engaging units, the hydraulic system comprising: a plurality of unit cylinder actuators; a source of fluid, wherein the source is fluidly coupled to the plurality of unit cylinder actuators; and an intensifier that is fluidly coupled to the plurality of unit cylinder actuators, wherein the intensifier (i) receives fluid from a first subset of unit cylinder actuators of the plurality of unit cylinder actuators, and (ii) provides fluid having an increased pressure level relative to pressure level of received fluid to a second subset of unit cylinder actuators of the plurality of unit cylinder actuators, thereby supplementing fluid from the source.

EEE 2 is the hydraulic system of EEE 1, wherein the intensifier comprises: an intensifier cylinder actuator having an intensifier cylinder and an intensifier piston movable within the intensifier cylinder, wherein the intensifier piston divides an internal space of the intensifier cylinder into a head chamber and a rod chamber, wherein fluid received from the first subset of unit cylinder actuators is received at the head chamber, and wherein fluid provided by the intensifier is provided via the rod chamber.

EEE 3 is the hydraulic system of EEE 2, wherein the source is fluidly coupled to the rod chamber of the intensifier such that the source is fluidly coupled to the plurality of unit cylinder actuators via the rod chamber of the intensifier.

EEE 4 is the hydraulic system of EEE 3, further comprising: a check valve that allows fluid flow from the source to the rod chamber, while preventing back flow from the rod chamber to the source.

EEE 5 is the hydraulic system of EEE 4, wherein the intensifier and the check valve are integrated into a manifold having respective ports fluidly coupled to the plurality of unit cylinder actuators.

EEE 6 is the hydraulic system of any of EEEs 2-5, further comprising: a fluid reservoir that is fluidly coupled to the head chamber such that the fluid reservoir is fluidly coupled to the plurality of unit cylinder actuators via the head chamber of the intensifier.

EEE 7 is the hydraulic system of any of EEEs 1-6, wherein each unit cylinder actuator of the plurality of the unit cylinder actuators has (i) a cylinder, and (ii) a piston movable in the cylinder, wherein the first subset of unit cylinder actuators has respective pistons moving in a first direction, and wherein the second subset of unit cylinder actuators has respective pistons moving in a second direction.

EEE 8 is the hydraulic system of EEE 7, wherein the piston divides the cylinder into a first chamber and a second chamber, and wherein the hydraulic system further comprises: a proportional pressure control valve that fluidly couples the source to the first chamber.

EEE 9 is the hydraulic system of EEE 8, wherein the proportional pressure control valve is electrically-actuated such that pressure level of fluid provided to the first chamber varies based on a magnitude of an electric command to the proportional pressure control valve.

EEE 10 is the hydraulic system of any of EEEs 8-9, further comprising: a pressure control valve that fluidly couples the source to the second chamber such that the pressure control valve provides fluid at a substantially constant pressure to the second chamber.

EEE 11 is a surface engaging machine including the hydraulic system of any of EEEs 1-10. For example, the surface engaging machine comprises: a plurality of surface engaging units, each surface engaging unit having a respective unit cylinder actuator; a source of fluid that is fluidly coupled to respective unit cylinder actuators of the plurality of surface engaging unit; and an intensifier that is fluidly coupled to the respective unit cylinder actuators, wherein the intensifier (i) receives fluid from a first subset of unit cylinder actuators of the respective unit cylinder actuators, and (ii) provides fluid having an increased pressure level relative to pressure level of received fluid to a second subset of unit cylinder actuators of the respective unit cylinder actuators, thereby supplementing fluid from the source.

EEE 12 is the surface engaging machine of EEE 11, wherein the intensifier comprises: an intensifier cylinder actuator having an intensifier cylinder and an intensifier piston movable within the intensifier cylinder, wherein the intensifier piston divides an internal space of the intensifier cylinder into a head chamber and a rod chamber, wherein fluid received from the first subset of unit cylinder actuators is received at the head chamber, and wherein fluid provided by the intensifier is provided via the rod chamber.

EEE 13 is the surface engaging machine of EEE 12, wherein the source is fluidly coupled to the rod chamber of the intensifier such that the source is fluidly coupled to the respective unit cylinder actuators via the rod chamber of the intensifier.

EEE 14 is the surface engaging machine of EEE 13, further comprising: a check valve that allows fluid flow from the source to the rod chamber, while preventing back flow from the rod chamber to the source.

EEE 15 is the surface engaging machine of EEE 14, wherein the intensifier and the check valve are integrated into a manifold having respective ports fluidly coupled to the respective unit cylinder actuators.

EEE 16 is the surface engaging machine of any of EEEs 12-15, further comprising: a fluid reservoir that is fluidly coupled to the head chamber such that the fluid reservoir is fluidly coupled to the respective unit cylinder actuators via the head chamber of the intensifier.

EEE 17 is the surface engaging machine of any of EEEs 11-16, wherein each unit cylinder actuator of the respective unit cylinder actuators has (i) a cylinder, and (ii) a piston movable in the cylinder, wherein the first subset of unit cylinder actuators has respective pistons moving in a first direction, and wherein the second subset of unit cylinder actuators has respective pistons moving in a second direction.

EEE 18 is the surface engaging machine of EEE 17, wherein the piston divides the cylinder into a first chamber and a second chamber, and wherein a respective surface engaging unit comprises: a proportional pressure control valve that fluidly couples the source to the first chamber, wherein the proportional pressure control valve is electrically-actuated such that pressure level of fluid provided to the first chamber varies based on a magnitude of an electric command to the proportional pressure control valve.

EEE 19 is the surface engaging machine of EEE 18, wherein the respective surface engaging unit further comprises: a pressure control valve that fluidly couples the source to the second chamber such that the pressure control valve provides fluid at a substantially constant pressure to the second chamber.

EEE 20 is a method of operating the hydraulic system of any of EEEs 1-10 or the surface engaging machine of any of EEEs 11-19. For example, the method comprises: providing fluid from a source of fluid to a plurality of unit cylinder actuators of a surface engaging machine, each unit cylinder actuators having a respective piston movable within a respective cylinder; receiving fluid from a first subset of unit cylinder actuators of the plurality of unit cylinder actuators having pistons moving in a first direction; intensifying pressure level of fluid received from the first subset of unit cylinder actuators; and providing fluid having intensified pressure level to a second subset of unit cylinder actuators of the plurality of unit cylinder actuators having pistons moving in a second direction, thereby supplementing fluid from the source.

What is claimed is:

1. A hydraulic system for a surface engaging machine having a plurality of surface engaging units, the hydraulic system comprising:
a plurality of unit cylinder actuators;
a source of fluid, wherein the source is fluidly coupled to the plurality of unit cylinder actuators; and
an intensifier that is fluidly coupled to the plurality of unit cylinder actuators, wherein the intensifier (i) receives fluid from a first subset of unit cylinder actuators of the plurality of unit cylinder actuators, and (ii) provides fluid having an increased pressure level relative to pressure level of received fluid to a second subset of unit cylinder actuators of the plurality of unit cylinder actuators, thereby supplementing fluid from the source.

2. The hydraulic system of claim 1, wherein the intensifier comprises:
an intensifier cylinder actuator having an intensifier cylinder and an intensifier piston movable within the intensifier cylinder, wherein the intensifier piston divides an internal space of the intensifier cylinder into a head chamber and a rod chamber, wherein fluid received from the first subset of unit cylinder actuators is received at the head chamber, and wherein fluid provided by the intensifier is provided via the rod chamber.

3. The hydraulic system of claim 2, wherein the source is fluidly coupled to the rod chamber of the intensifier such that the source is fluidly coupled to the plurality of unit cylinder actuators via the rod chamber of the intensifier.

4. The hydraulic system of claim 3, further comprising:
a check valve that allows fluid flow from the source to the rod chamber, while preventing back flow from the rod chamber to the source.

5. The hydraulic system of claim 4, wherein the intensifier and the check valve are integrated into a manifold having respective ports fluidly coupled to the plurality of unit cylinder actuators.

6. The hydraulic system of claim 2, further comprising:
a fluid reservoir that is fluidly coupled to the head chamber such that the fluid reservoir is fluidly coupled to the plurality of unit cylinder actuators via the head chamber of the intensifier.

7. The hydraulic system of claim 1, wherein each unit cylinder actuator of the plurality of the unit cylinder actuators has (i) a cylinder, and (ii) a piston movable in the cylinder, wherein the first subset of unit cylinder actuators has respective pistons moving in a first direction, and wherein the second subset of unit cylinder actuators has respective pistons moving in a second direction.

8. The hydraulic system of claim 7, wherein the piston divides the cylinder into a first chamber and a second chamber, and wherein the hydraulic system further comprises:
a proportional pressure control valve that fluidly couples the source to the first chamber.

9. The hydraulic system of claim 8, wherein the proportional pressure control valve is electrically-actuated such that pressure level of fluid provided to the first chamber varies based on a magnitude of an electric command to the proportional pressure control valve.

10. The hydraulic system of claim 8, further comprising:
a pressure control valve that fluidly couples the source to the second chamber such that the pressure control valve provides fluid at a substantially constant pressure to the second chamber.

11. A surface engaging machine comprising:
a plurality of surface engaging units, each surface engaging unit having a respective unit cylinder actuator;
a source of fluid that is fluidly coupled to respective unit cylinder actuators of the plurality of surface engaging unit; and
an intensifier that is fluidly coupled to the respective unit cylinder actuators, wherein the intensifier (i) receives fluid from a first subset of unit cylinder actuators of the respective unit cylinder actuators, and (ii) provides fluid having an increased pressure level relative to pressure level of received fluid to a second subset of unit cylinder actuators of the respective unit cylinder actuators, thereby supplementing fluid from the source.

12. The surface engaging machine of claim 11, wherein the intensifier comprises:
an intensifier cylinder actuator having an intensifier cylinder and an intensifier piston movable within the intensifier cylinder, wherein the intensifier piston divides an internal space of the intensifier cylinder into a head chamber and a rod chamber, wherein fluid received from the first subset of unit cylinder actuators is received at the head chamber, and wherein fluid provided by the intensifier is provided via the rod chamber.

13. The surface engaging machine of claim 12, wherein the source is fluidly coupled to the rod chamber of the intensifier such that the source is fluidly coupled to the respective unit cylinder actuators via the rod chamber of the intensifier.

14. The surface engaging machine of claim 13, further comprising:
a check valve that allows fluid flow from the source to the rod chamber, while preventing back flow from the rod chamber to the source.

15. The surface engaging machine of claim 14, wherein the intensifier and the check valve are integrated into a manifold having respective ports fluidly coupled to the respective unit cylinder actuators.

16. The surface engaging machine of claim 12, further comprising:
a fluid reservoir that is fluidly coupled to the head chamber such that the fluid reservoir is fluidly coupled to the respective unit cylinder actuators via the head chamber of the intensifier.

17. The surface engaging machine of claim 11, wherein each unit cylinder actuator of the respective unit cylinder actuators has (i) a cylinder, and (ii) a piston movable in the cylinder, wherein the first subset of unit cylinder actuators has respective pistons moving in a first direction, and wherein the second subset of unit cylinder actuators has respective pistons moving in a second direction.

18. The surface engaging machine of claim 17, wherein the piston divides the cylinder into a first chamber and a second chamber, and wherein a respective surface engaging unit comprises:
a proportional pressure control valve that fluidly couples the source to the first chamber, wherein the proportional pressure control valve is electrically-actuated such that pressure level of fluid provided to the first chamber varies based on a magnitude of an electric command to the proportional pressure control valve.

19. The surface engaging machine of claim 18, wherein the respective surface engaging unit further comprises:
a pressure control valve that fluidly couples the source to the second chamber such that the pressure control valve provides fluid at a substantially constant pressure to the second chamber.

20. A method comprising:
providing fluid from a source of fluid to a plurality of unit cylinder actuators of a surface engaging machine, each unit cylinder actuators having a respective piston movable within a respective cylinder;
receiving fluid from a first subset of unit cylinder actuators of the plurality of unit cylinder actuators having pistons moving in a first direction;
intensifying pressure level of fluid received from the first subset of unit cylinder actuators; and
providing fluid having intensified pressure level to a second subset of unit cylinder actuators of the plurality of unit cylinder actuators having pistons moving in a second direction, thereby supplementing fluid from the source.
